(19) United States
(12) Patent Application Publication
(10) Pub. No.: US 2011/0260931 A1
(43) Pub. Date: Oct. 27, 2011

(54) Antenna Module, and Electronic Apparatus Including the Antenna Module

(75) Inventors: Tiao-Hsing Tsai, Yunghe City (TW); Ying-Chih Wang, Tao Yuan Shien (TW); Jui-Teng Cheng, Kaohsiung City (TW)

(73) Assignee: Quanta Computer Inc., Tao Yuan Shien (TW)

(21) Appl. No.: 12/883,719

(22) Filed: Sep. 16, 2010

(30) Foreign Application Priority Data
Apr. 27, 2010 (TW) 099113273

(51) Int. Cl. H01Q 9/04; H01Q 21/00; H01Q 1/24

(52) U.S. Cl. 343/702; 343/893; 343/700 MS

(57) ABSTRACT

An antenna module is adapted for disposing in an electronic apparatus that includes first and second housing members and that is operable in a tablet mode, in which the first and second housing members are disposed in a manner that the first housing member overlaps the second housing member. The antenna module includes: a first antenna element to be disposed in the first housing member; and a second antenna element to be disposed in the second housing member, and corresponding substantially in position and proximate to the first antenna element for electromagnetic coupling therewith when the electronic apparatus is operated in the tablet mode.

### CROSS-REFERENCE TO RELATED APPLICATION

This application claims priority of Taiwanese Application No. 099113273, filed on Apr. 27, 2010.

### BACKGROUND OF THE INVENTION

1. Field of the Invention

The present invention relates to an antenna module and an electronic apparatus having the same.

2. Description of the Related Art

Nowadays, some portable computers are installed with antenna modules operable at frequencies ranging from 824 MHz to 960 MHz and from 1710 MHz to 2170 MHz for access to Wireless Wide Area Networks (WWAN). It is noted that such antenna modules are generally installed inside the frame of a display housing member, and along a periphery of the frame to thereby reduce electromagnetic interference from electronic components and metal conductors of the portable computers.

Nonetheless, one problem that resides in portable computers operable in a tablet mode is that, when the portable computers are operated in the tablet mode, performance of the antenna module is compromised due to interference from electronic components and metal conductors in the body housing member as the display housing member and the body housing member are disposed in a manner that the display housing member overlaps the body housing member.

Therefore, how to improve performance of the antenna module when the portable computer is operated in the tablet mode is a subject of improvement of the present invention.

### SUMMARY OF THE INVENTION

Therefore, an object of the present invention is to provide an antenna module capable of alleviating the aforesaid drawback of the prior art.

Accordingly, an antenna module of the present invention is adapted for disposing in an electronic apparatus that includes first and second housing members and that is operable in a tablet mode, in which the first and second housing members are disposed in a manner that the first housing member overlaps the second housing member. The antenna module includes: a first antenna element to be disposed in the first housing member; and a second antenna element to be disposed in the second housing member, and corresponding substantially in position and proximate to the first antenna element for electromagnetic coupling therewith when the electronic apparatus is operated in the tablet mode.

Another object of the present invention is to provide an electronic apparatus capable of alleviating the aforesaid drawback of the prior art.

Accordingly, an electronic apparatus of the present invention is operable in a tablet mode, and includes: first and second housing members, and an antenna module. The first and second housing members are coupled pivotally and are configured in a manner that the first housing member overlaps the second housing member when the electronic apparatus operates in the tablet mode. The antenna module includes a first antenna element disposed in the first housing member, and a second antenna element disposed in the second housing member, and corresponding substantially in position and proximate to the first antenna element for electromagnetic coupling therewith when the electronic apparatus is operated in the tablet mode.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electronic apparatus according to the present invention;

FIG. 2 is a fragmentary schematic diagram illustrating a display housing member overlapping a body housing member of the electronic apparatus;

FIG. 3 is a schematic diagram illustrating one side of a substrate of an antenna module of the electronic apparatus that is disposed in the display housing member;

FIG. 4 is a schematic diagram illustrating another side of the substrate;

FIG. 5 is a schematic diagram illustrating a spacer of the antenna module that is disposed in the body housing member;

FIG. 6 is a fragmentary schematic diagram illustrating the spacer and an inner wall surface of the body housing member;

FIG. 7 is a Voltage Standing Wave Ratio (VSWR) plot of an antenna module of an electronic apparatus that does not include a coupling antenna element;

FIG. 8 is a VSWR plot of the antenna module of the electronic apparatus of the preferred embodiment, which includes a coupling antenna element; and

FIGS. 9 and 10 are radiation patterns of the antenna module of the electronic apparatus of the preferred embodiment at 897.4 MHz and 1747.8 MHz, respectively.

### DETAILED DESCRIPTION OF THE PREFERRED EMBODIMENT

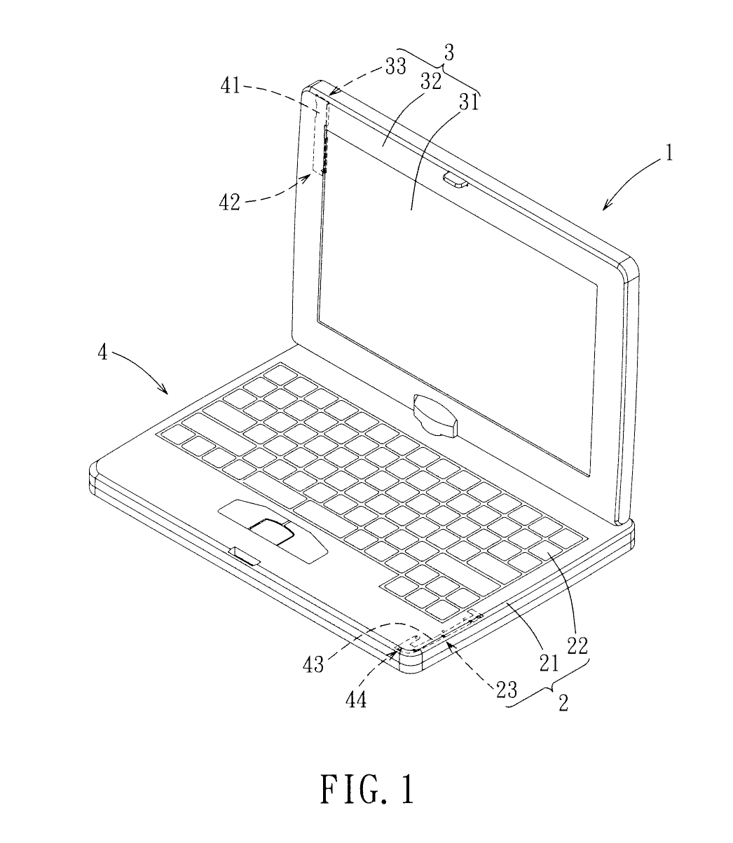

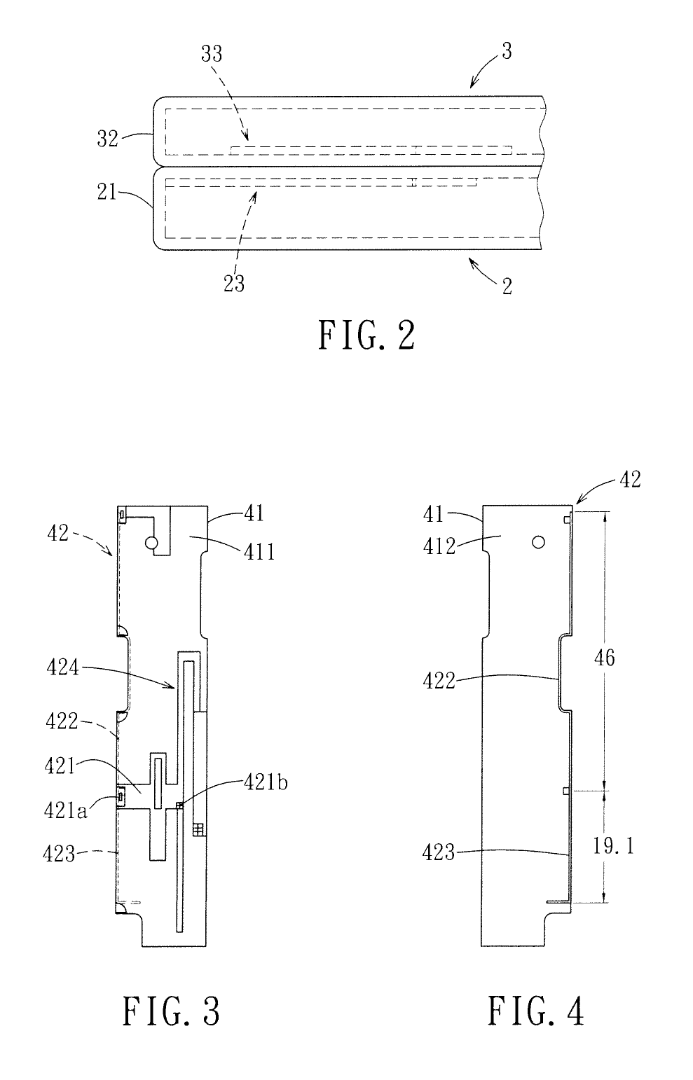

Referring to FIG. 1, the preferred embodiment of an electronic apparatus 1 according to the present invention is exemplified as a portable computer. However, the electronic apparatus 1 may be implemented differently in other embodiments. The electronic apparatus 1 includes a body housing member 2, a display housing member 3, and an antenna module 4, and is operable in a normal mode and a tablet mode. The display housing member 3 is coupled pivotally to the body housing member 2, is disposed substantially perpendicular thereto when the electronic apparatus 1 is operated in the normal mode, and is disposed to overlap the body housing member 2 when the electronic apparatus 1 is operated in the tablet mode, as best illustrated in FIG. 2.

The body housing member 2 includes a metal frame 21, a keyboard 22 mounted on the metal frame 21, and electronic components (not shown) installed in the metal frame 21. Furthermore, a first region 23 is defined in the body housing member 2. The display housing member 3 includes a display panel 31 and a peripheral frame 32. Moreover, a second region 33 is defined in the display housing member 3. Referring to FIG. 2, when the electronic apparatus 1 is operated in the tablet mode, the second region 33 overlaps the first region 23.

The antenna module 4 includes a substrate 41 disposed in the second region 33 of the display housing member 3, a radiator antenna element 42 disposed on the substrate 41, a spacer 43 disposed in the first region 23 of the body housing member 2, and a coupling antenna element 44 disposed on the spacer 43. It is to be noted that, in other embodiments, the radiator antenna element 42 may be formed integrally from a metal plate such that the substrate 41 may be omitted.

Referring to FIGS. 3 and 4, the substrate 41 has opposite first and second sides 411, 412. When the electronic apparatus 1 is operated in the tablet mode, the first side 411 is proximate to the body housing member 2 relative to the second side 422. The radiator antenna element 42 includes a feed-in portion 421 disposed on the first side 411, first and second radiator portions 422, 423 disposed on the second side 412, and a grounding section 424 disposed on the first side 411. The first and second radiator portions 422, 423 are connected electrically to each other and are elongate metal pieces (iron pieces) arranged substantially along a longitudinal direction of the substrate 41.

The feed-in section 421 has a first end 421a connected electrically to a via hole that extends through the first and second sides 411, 412, and a second end 421b opposite to the first end 421a and serving as a feed-in point for feeding of signals. The grounding section 424 is connected electrically to the second end 421b of the feed-in section 421, and has one end connected electrically to a ground plane of the electronic apparatus 1. The first end 421a of the feed-in section 421 is connected electrically to a connecting junction of the first and second radiator portions 422, 423 via the via hole.

It is worth noting that, in the present embodiment, the first and second radiator portions 422, 423 are operable in lower (i.e., 824 MHz to 960 MHz) and higher (i.e., 1710 MHz to 2170 MHz) frequency sub-bands of the Wireless Wide Area Network (WWAN) frequency band, respectively.

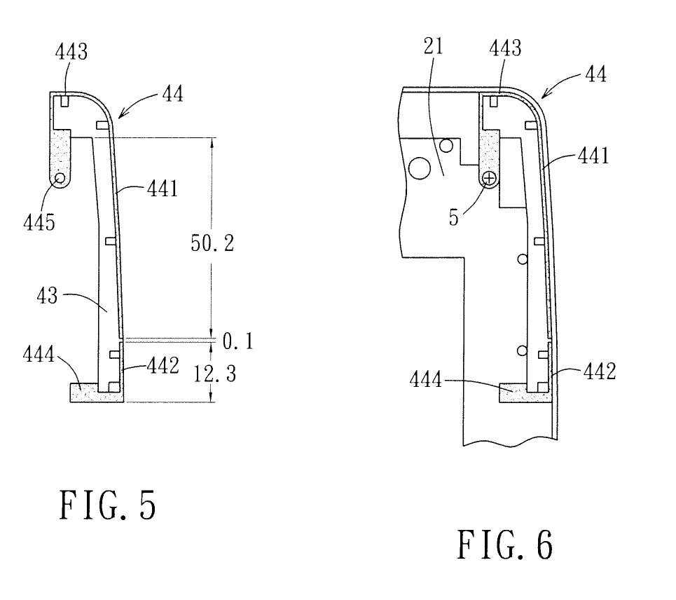

Referring to FIGS. 5 and 6, the coupling antenna element 44 includes first and second coupling portions 441, 442 and first and second grounding portions 443, 444 that are disposed along a peripheral edge of the spacer 43. The first and second coupling portions 441, 442 are elongated and arranged substantially along a straight line. The first and second coupling portions 441, 442 have proximate ends that are proximate to and spaced apart from each other, and have distal ends that are distal from each other and that are connected electrically and respectively to the first and second grounding portions 443, 444, which in turn are connected electrically to the metal frame 21 of the body housing member 2, the metal frame 21 serving as the ground plane of the electronic apparatus 1. It is to be noted that, when the electronic apparatus 1 is operated in the tablet mode, the first and second coupling portions 441, 442 correspond substantially in position and are proximate to the first and second radiator portions 422, 423, and cooperate through electromagnetic coupling therewith to resonate in the lower and higher frequency sub-bands, respectively.

Moreover, the first grounding portion 443 has a distal end distal from the first coupling portion 441 and formed with a threaded hole 445 that is adapted for threaded engagement and electrical connection with a grounding element 5 of the body housing member 2, which is connected electrically to the metal frame 21 (i.e., the ground plane of the electronic apparatus 1). The grounding element 5 is a screw in this embodiment. The second grounding portion 444 is disposed to abut against an inner wall surface of the metal frame 21 to connect electrically therewith.

In the present embodiment, the spacer 43 is made of a plastic material for providing the effect of electrical isolation with the metal frame 21, which serves as the ground plane. The spacer 43 may be adhered to the inner wall surface of the metal frame 21. Furthermore, the coupling antenna element 44 is formed from a copper foil and is adhered onto a surface of the spacer 43 that is opposite to the inner wall surface of the metal frame 21.

Referring once again to FIG. 4, in the present embodiment, the first and second radiator portions 422, 423 have dimensions of 46 mm and 19.1 mm, respectively. Referring once again to FIG. 5, in the present embodiment, the first and second coupling portions 441, 442 have dimensions of 50.2 mm and 12.3 mm, respectively.

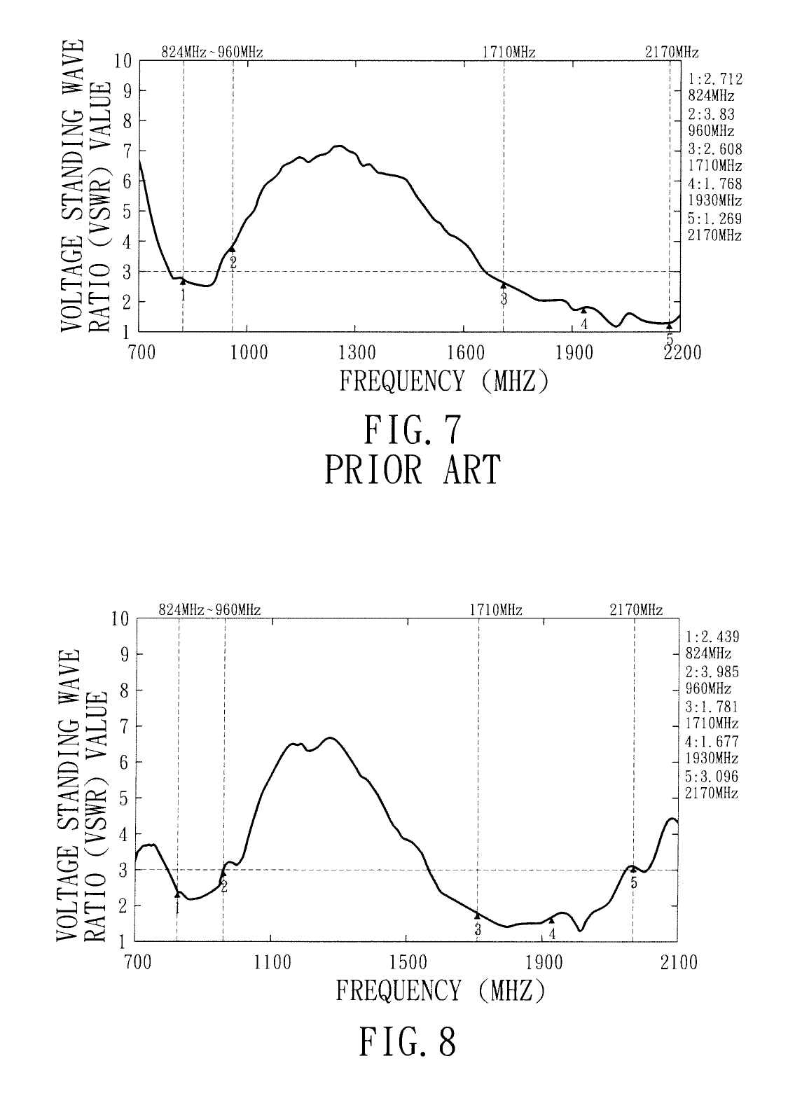

Shown in FIG. 7 is a measured Voltage Standing Wave Ratio (VSWR) plot of an electronic apparatus that does not have the coupling antenna element 44 and that is operated in a tablet mode. In comparison, shown in FIG. 8 is a measured VSWR plot of the electronic apparatus 1 of the preferred embodiment operated in the tablet mode. It is apparent from FIGS. 7 and 8 that the antenna module 4 of the electronic apparatus 1 of the preferred embodiment has VSWR values lower than 3 in the WWAN frequency band.

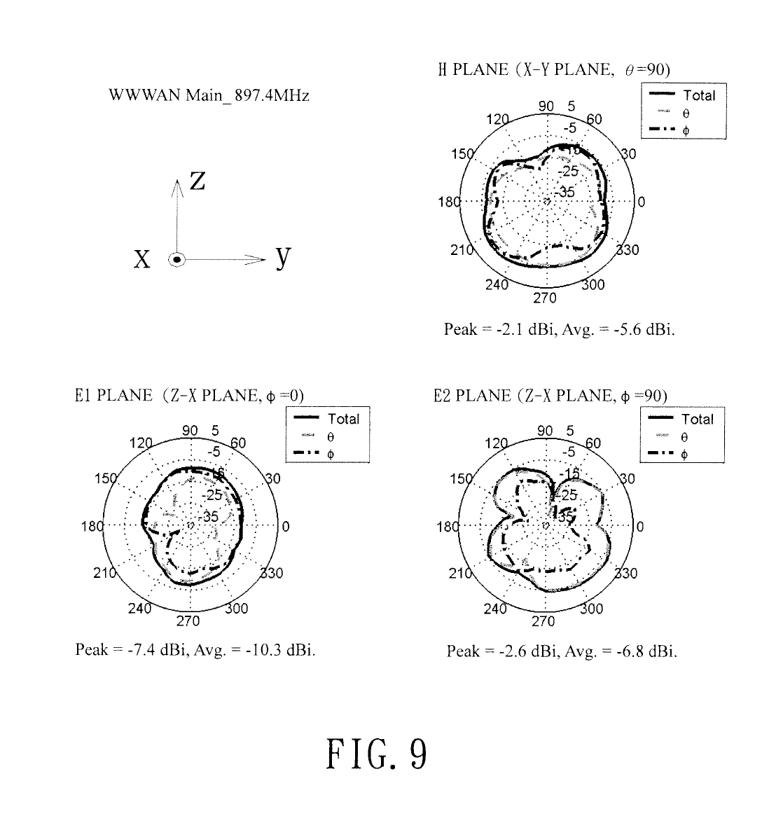

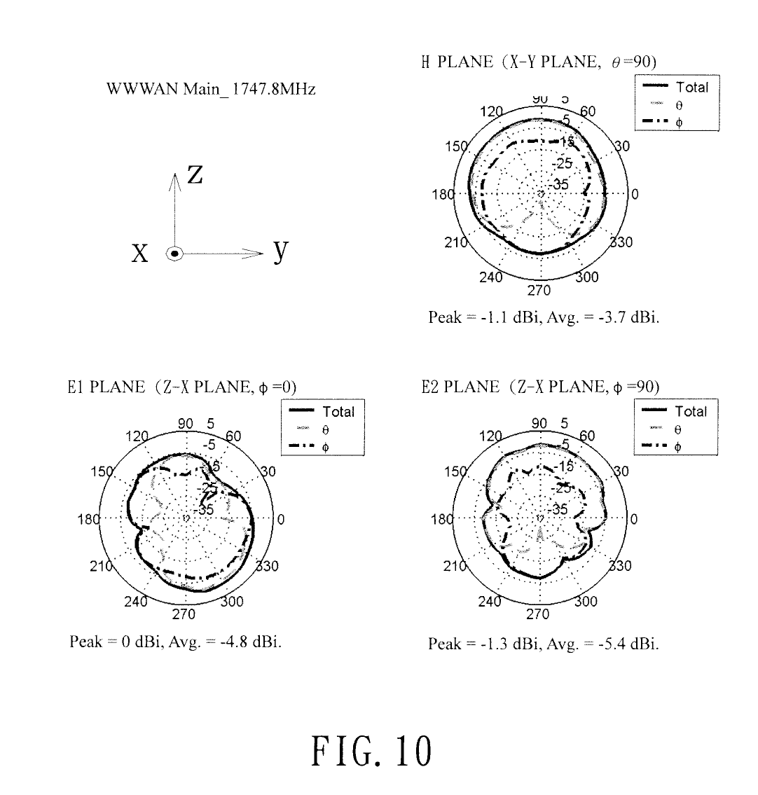

Shown in FIGS. 9 and 10 are radiation patterns of the antenna module 4 at 897.4 MHz and 1747.8 MHz, respectively. The radiation patterns are viewed in the X-Y, Z-X, and Z-X planes. The darker dashed-line, the lighter dashed-line, and the solid line represent the magnetic field (Phi), the electric field (Theta), and the total of the magnetic and electric fields, respectively. It is apparent that the antenna module 4 has substantially omni-directional radiation patterns at 897.4 MHz and 1747.8 MHz.

In summary, through disposing each of the radiator antenna element 42 and the coupling antenna element 44 in a respective one of the display housing member 3 and the body housing member 2, cooperative electromagnetic coupling is achieved by the radiator antenna element 42 and the coupling antenna element 44 so as to alleviate the effect of interference from other electronic components and metal conductors of the electronic apparatus 1 when the electronic apparatus 1 is operated in the tablet mode.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna module adapted for disposing in an electronic apparatus that includes first and second housing members and that is operable in a tablet mode, in which the first and second housing members are disposed in a manner that the first housing member overlaps the second housing member, said antenna module comprising:
a first antenna element to be disposed in the first housing member; and
a second antenna element to be disposed in the second housing member, and corresponding substantially in position and proximate to said first antenna element for electromagnetic coupling therewith when the electronic apparatus is operated in the tablet mode.

2. The antenna module as claimed in claim 1, wherein:
one of said first and second antenna elements includes first and second radiator portions that are resonant in first and second frequency bands, respectively; and
the other of said first and second antenna elements includes first and second coupling portions that are proximate to and correspond substantially in position to said first and second radiator portions, and that cooperate therewith to resonate in the first and second frequency bands, respectively, when the electronic apparatus is operated in the tablet mode.

3. The antenna module as claimed in claim 2, wherein said one of said first and second antenna elements further includes a feed-in portion that is connected electrically to said first and second radiator portions for feeding of signals.

4. The antenna module as claimed in claim 3, further comprising a substrate to be disposed in one of the first and second housing members, wherein said first and second radiator portions and said feed-in portion are disposed on said substrate in the first housing member.

5. The antenna module as claimed in claim 4, wherein said substrate has opposite first and second sides, said first and second radiator portions being disposed on said second side of said substrate, said feed-in portion being disposed on said first side of said substrate.

6. The antenna module as claimed in claim 5, wherein said first and second radiator portions are connected electrically to each other, said feed-in portion being connected electrically to a connecting junction of said first and second radiator portions via a via hole.

7. The antenna module as claimed in claim 2, wherein said first and second coupling portions are arranged substantially along a straight line.

8. The antenna module as claimed in claim 7, wherein said first and second coupling portions have distal ends distal from each other, the other of said first and second antenna elements further including a first grounding portion connected electrically to said distal end of said first coupling portion and adapted to be connected electrically to a ground plane of the electronic apparatus, and a second grounding portion connected electrically to said distal end of said second coupling portion and adapted to be connected electrically to the ground plane.

9. The antenna module as claimed in claim 8, the electronic apparatus further including a grounding element that is connected electrically to the ground plane, wherein said first grounding portion is formed with a through hole adapted for fastening and electrical connection with the grounding element.

10. The antenna module as claimed in claim 9, wherein said through hole is a threaded hole for threaded engagement with the grounding element.

11. The antenna module as claimed in claim 8, wherein said first and second coupling portions further have proximate ends proximate to and spaced apart from each other.

12. An electronic apparatus operable in a tablet mode, comprising:
first and second housing members that are coupled pivotally and are configured in a manner that said first housing member overlaps said second housing member when the electronic apparatus operates in the tablet mode; and
an antenna module including
a first antenna element disposed in said first housing member, and
a second antenna element disposed in said second housing member, and corresponding substantially in position and proximate to said first antenna element for electromagnetic coupling therewith when the electronic apparatus is operated in the tablet mode.

13. The electronic apparatus as claimed in claim 12, wherein:
one of said first and second antenna elements includes first and second radiator portions that are resonant in first and second frequency bands, respectively; and
the other of said first and second antenna elements includes first and second coupling portions that are proximate to and correspond substantially in position to said first and second radiator portions, and that cooperate therewith to resonate in the first and second frequency bands, respectively, when the electronic apparatus is operated in the tablet mode.

14. The electronic apparatus as claimed in claim 13, wherein said one of said first and second antenna elements further includes a feed-in portion that is connected electrically to said first and second radiator portions for feeding of signals.

15. The electronic apparatus as claimed in claim 14, wherein said antenna module further includes a substrate disposed in one of said first and second housing members, said first and second radiator portions and said feed-in portion being disposed on said substrate in said first housing member.

16. The electronic apparatus as claimed in claim 15, wherein said substrate has opposite first and second sides, said first and second radiator portions being disposed on said second side of said substrate, said feed-in portion being disposed on said first side of said substrate.

17. The electronic apparatus as claimed in claim 16, wherein said first and second radiator portions are connected electrically to each other, said feed-in portion being connected electrically to a connecting junction of said first and second radiator portions via a via hole.

18. The electronic apparatus as claimed in claim 13, wherein said first and second coupling portions are arranged substantially along a straight line.

19. The electronic apparatus as claimed in claim 18, wherein said second housing member includes a metal frame serving as a ground plane, said second antenna element including said first and second coupling portions, said first and second coupling portions having distal ends distal from each other, said second antenna element further including a first grounding portion connected electrically to said distal end of said first coupling portion and the ground plane, and a second grounding portion connected electrically to said distal end of said second coupling portion and the ground plane.

20. The electronic apparatus as claimed in claim 19, wherein said second housing member further includes a grounding element that is connected electrically to the ground plane, said first grounding portion being formed with a through hole for fastening and electrical connection with said grounding element.

21. The electronic apparatus as claimed in claim 20, wherein said through hole is a threaded hole for threaded engagement with said grounding element.

22. The electronic apparatus as claimed in claim 19, wherein said first and second coupling portions further have proximate ends proximate to and spaced apart from each other.
